(19) United States
(12) Patent Application Publication
(10) Pub. No.: US 2026/0323490 A1
(43) Pub. Date: Oct. 15, 2026

(54) SWAPPED SECTOR IDENTIFICATION

(71) Applicant: T-Mobile Innovations LLC, Overland Park, KS (US)

(72) Inventor: Sonny RAFIQ, Herndon, VA (US)

(21) Appl. No.: 19/178,110

(22) Filed: Apr. 14, 2025

(51) Int. Cl. H04W 48/16; H04B 17/318; H04W 4/021; H04W 4/38

(52) U.S. Cl. CPC H04W 48/16; H04B 17/318; H04W 4/021; H04W 4/38

(57) ABSTRACT

Methods and systems described herein provide for swapped sector identification within a cell site. Methods include comparing crowd-sourced samples from wireless devices to network data stored in a network database and calculating a delta between the crowd-sourced samples and the network data. Methods further include identifying a swapped sector based on the delta.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes. Newer networks introduce new features as well as new challenges.

Currently, a common fault in mobile communications networks is the presence of swapped sectors. Swapped sectors occur when the coverage areas of two or more co-located sectors are swapped. For example, antennas located at the same base station may have their connections from their ports to radio units or baseband units of the base station inadvertently swapped. Swapping of sectors can occur, for example, during installation and/or maintenance activities. The swapped sectors can cause performance degradation and result in extra effort for cellular network engineers.

Swapped sectors are typically not instantly detected and are usually only discovered as the result of a drive test analysis, which can be time consuming and expensive. Further solutions are needed for identifying and remediating swapped sectors.

### OVERVIEW

Exemplary embodiments provided herein include a method for identifying and remediating swapped sectors. The method includes comparing crowd-sourced samples from wireless devices to network data stored in a network database and calculating a delta between the crowd-sourced samples and the network data. The method further includes identifying a swapped sector based on the delta, wherein the swapped sector occurs when coverage areas of two or more co-located sectors are inadvertently swapped.

In further embodiments, a swapped sector identification system is provided. The swapped sector identification system includes a memory storing data and instructions and a processor executing the stored instructions to perform multiple operations. The operations include comparing crowd-sourced samples from wireless devices to network data stored in a network database in the memory and calculating a delta between the crowd-sourced samples and the network data. The operations further include identifying a swapped sector based on the delta.

In a further embodiment, a non-transitory computer-readable medium stores instructions executed by a processor to perform multiple operations. The operations include comparing crowd-sourced samples from wireless devices to network data stored in a network database and calculating a delta between the crowd-sourced samples and the network data. The operations additionally include identifying a swapped sector based on the delta.

Further embodiments include processing nodes performing the operations described above.

### BRIEF DESCRIPTION OF THE DRAWINGS

FIG. 1 depicts an exemplary environment for swapped sector identification system in accordance with an embodiment.

FIG. 2 depicts a swapped sector identification system in accordance with an embodiment.

FIG. 3A depicts an exemplary operating environment for a swapped sector identification system in accordance with an embodiment.

FIG. 3B depicts an example of a swapped sector within the above-described operating environment in accordance with an embodiment.

FIG. 4 depicts a method for swapped sector identification in accordance with an embodiment.

FIG. 5 depicts a further method for swapped sector identification in accordance with an embodiment.

### DETAILED DESCRIPTION

In embodiments disclosed herein, methods, systems, and non-transitory computer-readable mediums are provided for swapped sector identification. Swapped sector issues in cellular networks can arise due to several factors, including incorrect database input, misconfigured antenna connections during installation or during maintenance, which may be due to labeling issues.

Swapped sectors can lead to significant impacts, such as enhanced 911 (E911) calls being directed to the wrong public safety answering point (PSAP). Further, swapped sectors within a network can lead to inaccuracies in self-optimization network (SON) optimization. For example, SONs are programmed to increase the power of one transmitter if another nearby transmitter has insufficient power or is turned off. Thus, if sectors are swapped, the SON may take unnecessary actions as it accepts database information as accurate, when it is not in fact accurate in the case of swapped sectors. Additionally, swapped sectors can lead to issues with physical cell identity (PCI) or root sequence index (RSI) that can lead to degraded performance issues.

In embodiments provided herein, by utilizing available crowd-sourced network data with geolocation information, systems and methods can identify sites with swapped sector issues without the need for drive testing. The identification is achieved by comparing a sector antenna azimuth with crowd-sourced network data samples. The azimuth is the angle between a direction, e.g. north, and an object, measured clockwise in degrees. The crowd-sourced network data samples may be or include, for example, location data transmitted by wireless devices to the cell site or base station during the course of normal wireless device operation. Further, the crowd-sourced data may include signal strength data such reference signal received power (RSRP) or signal to noise and interference (SINR) data. Various programming tools, such Alteryx®, Python®, or Excel® can be utilized to make the comparison between the crowd-sourced data transmitted from wireless devices and the stored network data including the sector antenna azimuth. As a result of the comparison, systems and methods described herein are capable of identifying sites with swapped sectors and facilitating remediation for the swapped sectors.

Multiple architectures and methods can be utilized to identify and facilitate correction of swapped sectors. The identification process involves collecting data received from wireless devices or crowd-sourced data and stored network data identifying an antenna azimuth. The identification method further includes performing calculations based on this data to identify a delta and comparing the delta to a predetermined threshold in order to identify a swapped sector. Further, facilitating correction or remediation of swapped sectors may include triggering a notification or alarm in order to notify network engineers or enable automated deployment of maintenance technicians to correct the issues that caused the swapping of sectors.

In addition to the systems and methods described herein, non-transitory computer-readable mediums may store the operations or the instructions for performing various methods. Further, processing nodes on the network may execute the instructions or methods.

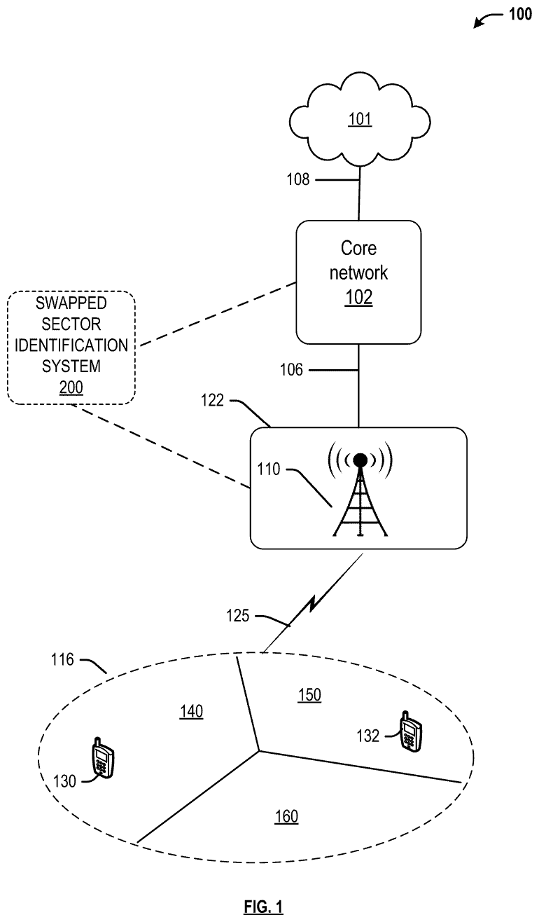

FIG. 1 depicts an exemplary environment 100 for implementing a swapped sector identification system 200. Environment 100 comprises a communication network 101, core network 102, and a radio access network (RAN) 122 including at least an access node 110. Further components, such as an Internet protocol (IP) multimedia subsystem (IMS) may be included, but are omitted for simplification. Wireless devices 130 and 132 are located in a coverage area 116 and communicate with the access node 110 over communication link 125. Although only two wireless devices 130, 132 are shown, it should be understood that any number of wireless devices could be included.

The core network 102 may include an SBA architecture, such as for 5G NR systems, in which service-based interfaces may be utilized between control plane functions, while multiple user plane functions connect over point-to-point link. Multiple network functions within the core network 102 may communicate with and subscribe to multiple other network functions. As an alternative, the core network 102 may have an evolved packet core (EPC) architecture, such as for 4G LTE systems.

The swapped sector identification system 200 is illustrated as communicating with or incorporated in the core network 102 or the RAN 122. For example, the swapped sector identification system may be incorporated at the access node 110. The swapped sector identification system 200 may further communicate with or be partially incorporated in various components of the core network 102 or the RAN 122. The swapped sector identification system 200 operates, for example, to store and/or access data received from the wireless device 130, 132. The swapped sector identification system 200 further operates on network data related to antennas at the access node 110. This data may be stored at the access node 110 and/or at the core network 102. The swapped sector identification system 200 may communicate findings of a swapped sector to the core network 102 for example.

The RAN 122 can include various access network functions and devices disposed between the core network 102 and the end-user wireless devices 130, 132. For example, the RAN 122 includes at least an access node (or base station), such as an eNodeB and/or a next generation NodeB (gNodeB) 110 communicating with the end-user wireless device 130. Further, either of core network 102 and radio access network 122 can include one or more of a local area network, a wide area network, and an internetwork (including the Internet) and be capable of communicating signals and carrying data, for example, to support voice, push-to-talk, broadcast video, and data communications by end-user wireless devices 130, 132.

Access node 110 can be any network node configured to provide communication between end-user wireless devices 130, 132 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 130, 132 are illustrated in FIG. 1, any number of access nodes and wireless devices can be implemented within environment 100.

Access node 110 can utilize antennas to deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Additionally, the coverage area 116 of the access node 110 may correspond to multiple sectors. In the illustrated embodiment, three sectors including a first sector 140, a second sector 150 and a third sector 160 are shown. Each sector may occupy 120 degrees and may correspond to an antenna of the access node 110.

Wireless devices 130, 132 may be any device, system, combination of devices, or other such communication platform capable of communicating wirelessly with access node 110 using one or more frequency bands deployed therefrom. Wireless devices 130, 132 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless devices 130, 132 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130, 132. Wireless network protocols can comprise multimedia broadcast multicast services (MBMS), code division multiple access (CDMA) single-Carrier radio transmission technology (1×RTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), Fifth Generation mobile networks or wireless systems (5G, 5G New Radio (“5G NR”), or 5G LTE), and/or other protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or other protocols. Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path—including combinations thereof. Communication links 106 and 108 can be wired or wireless and use various communication protocols such as Internet, Internet protocol (IP), local-area network (LAN), optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol as described herein. Communication links 106 and 108 can be a direct link or might include various equipment, intermediate components, systems, and networks. Communication links 106 and 108 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

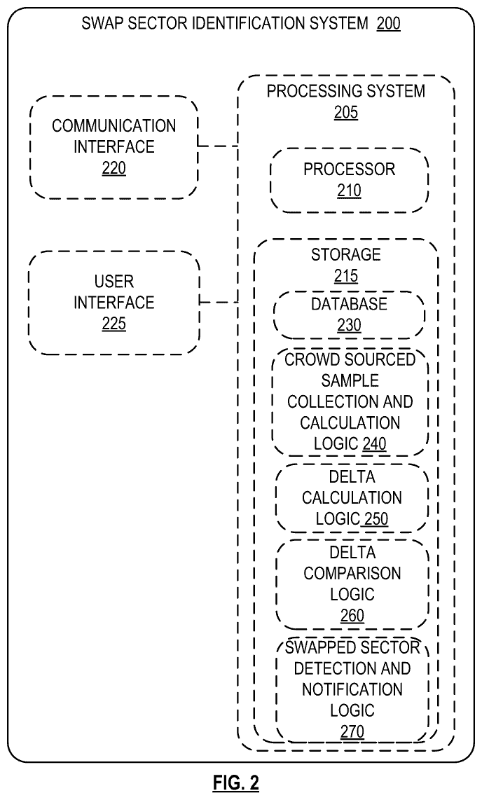

FIG. 2 illustrates a swapped sector identification system 200 in accordance with embodiments described herein. The components described herein are merely exemplary as many different configurations for the swapped sector identification system 200 may be implemented. The swapped sector identification system 200 may be configured to perform the methods and operations disclosed herein to identify swapped sectors within a network and trigger remediation of the swapped sectors. For example, the swapped sector identification system 200 may detect swapped sectors based on calculations performed on data stored in the network and data collected from wireless device or crowd-sourced data in order to identify the swapped sectors. Further, the swapped sector identification may trigger notifications upon detection of a swapped sector in order to initiate remediations to correct the swapped sectors. In the disclosed embodiments, the swapped sector identification system 200 may be integrated with the core network 102, the RAN 122 and/or the access node 110. Further, the components of the swapped sector identification system 200 may be distributed so that one or more components are located within the access node 110, the RAN 122, the core 102, and/or a separate processing node.

The swapped sector identification system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include one or more modules for performing various operations described herein.

For example, crowd-sourced sample collection and calculation logic 240 may be operable to collect wireless device data and perform calculations on the data, for example, to calculate a center of the crowd-sourced data. Delta calculation logic 250 may be operable to calculate a delta between the calculated center and an azimuth of the corresponding antenna. Further, delta comparison logic 260 may compare the delta calculated by the delta calculation logic 250 with a predetermined threshold delta. The predetermined threshold delta may be stored, for example, in a database 230 and may be network specific. For example, at a site having three sectors each covering one hundred twenty degrees, the predetermined threshold delta may be between fifty and seventy degrees and may optimally be about sixty degrees. If only two sectors are present such that each sector covers one hundred eighty degrees, then the predetermined threshold delta would likely be greater than sixty degrees, for example, ninety degrees, or between eighty degrees and one hundred degrees. Further, swapped sector detection and notification logic 270 may identify the swapped sectors based on the determination of the delta comparison logic and may trigger a notification. The notification may be triggered for automatic dispatch of network engineers or technicians to correct the issue giving rise to the swapped sectors. To perform the above-described operations, the crowd-sourced sample collection and calculation logic 240, the delta calculation logic 250, the delta comparison logic 260, and the swapped sector detection and notification logic 270 may be executed by the processor 210 to manage swapped sector identification and notification.

Processor 210 may be a microprocessor and may include hardware circuitry and/or embedded codes configured to retrieve and execute software stored in storage device 215. The swapped sector identification system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the swapped sector identification system 200 and receive data or information from other system components. User interface 225 may include hardware components, such as touch screens, buttons, displays, speakers, etc. The swapped sector identification system 200 may further include other components such as a power management unit, a control interface unit, etc.

The location of the swapped sector identification system 200 may depend upon the network architecture. As set forth above, the swapped sector identification system 200 may be located in the core network 102, the RAN 122, the access node 110, and/or in a separate processing node, or in multiple locations. Alternatively, the swapped sector identification system 200 may be an entirely discrete component. Further, although shown as a single integrated system, the functions of the swapped sector identification system 200 may be separated and may be disposed in separate locations.

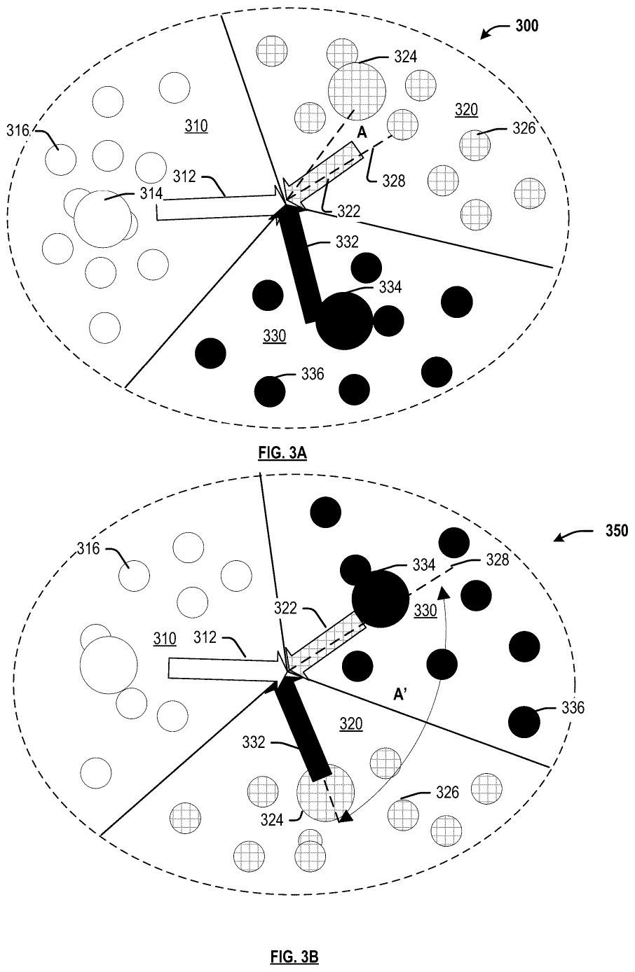

FIG. 3A illustrates an exemplary environment for swapped sector identification. Three sectors 310, 320, and 330 are illustrated as being deployed by corresponding antennas 312, 322, and 332. Crowd-sourced samples 316, 326, and 336 are represented by similarly sized circles in each of the sectors 310, 320, and 330. The crowd-sourced samples may include geolocation coordinates and are collected routinely and thus already present within the network. Geolocation coordinates and signal strength information are typically communicated from each wireless device to a corresponding cell site.

Circles 314, 324, and 334 represent a center of the crowd-sourced sample for each corresponding sector 310, 320, and 330. The determination of the center of the crowd-sourced sample can be made by averaging the coordinates of each sample. Each sample represented by the circles has a latitude and longitude. The center can be calculated by taking the average latitude and longitude and dividing by the number of samples.

Further, based on the calculated center, embodiments provided herein can determine a direction of the calculated center from the known location of the of the base station or access node supporting the antennas 312, 322, and 332.

Based on the location of the center of the samples and its direction from a sector antenna azimuth, e.g., 328 in sector 320, embodiments described herein calculate the delta between the sector antenna azimuth and the center of the samples. In the illustrated environment, a three hundred sixty degree site has three sectors. Thus, each sector 310, 320, 330 encompasses one hundred twenty degrees. Based on the angle encompassed by each sector, a predetermined threshold delta can be selected. For example, because sixty degrees is half of each one hundred twenty degree sector, the predetermined threshold may be selected to be sixty degrees or between fifty degrees and seventy degrees. Thus, if the predetermined threshold delta is sixty degrees, the center of the samples is located outside of the one hundred twenty degree sector area. When the center of samples for the sector is outside of the sector area, there is a high probability that the sector is swapped. If the sector is not swapped, there is a high probability that incorrect azimuth information has been utilized in the calculation.

A predetermined threshold delta for determining a swapped sector may differ based on the number of sectors. While the illustrated site has three sectors, some sites may have only two sectors. Accordingly, these sectors would encompass one hundred eighty degrees and the predetermined threshold delta may be set to be near ninety degrees as ninety degrees encompasses half of one sector. Similarly with four sectors, each sector would encompass ninety degrees and a predetermined threshold delta may be set at or around forty five degrees, which is one half of one sector.

Further, the angle A between the azimuth and the center 324 of the samples is compared to the predetermined threshold delta. In the example of FIG. 3A, the angle A is about thirty degrees, which is smaller than the predetermined threshold delta of sixty degrees. Therefore, it is unlikely that the sector 320 is a swapped sector.

FIG. 3B illustrates a further example of an environment for identification of a swapped sector. Identical reference numbers are used to refer to the same components described above with reference to FIG. 3B. In the illustrated architecture of FIG. 3B, sectors 320 and 330 can be identified as swapped sectors based on the analysis described above.

Specifically, the angle A′ between the azimuth 328 and the center 324 of samples is greater than a predetermined threshold angle. The angle A′ is about ninety degrees, which is greater than the sixty degree predetermined threshold described above. Therefore, it is likely that the sectors 320 and 330 are swapped sectors. Swapping of sectors often occurs when a repair is made and technicians misconnect antenna. This can cause multiple undesirable results, for example, emergency calls are directed to incorrect public safety answering points (PSAPs) or excessive interference occurs within the swapped sectors. The analysis described above can be accomplished with various coding tools, such as, for example, Alteryx®, Python®, or Excel®.

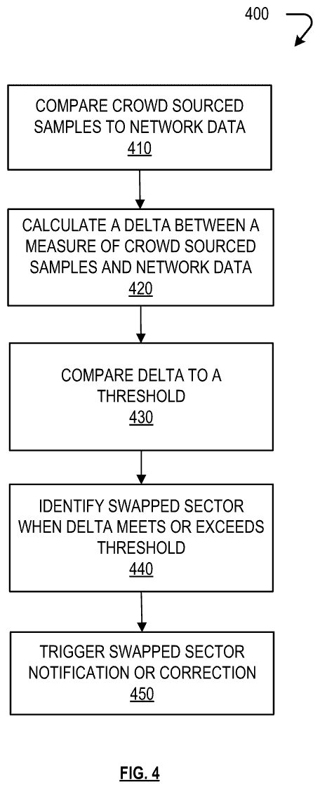

FIG. 4 depicts an exemplary method 400 for operation of the swapped sector identification system 200. Method 400 may be performed by any suitable processor discussed herein, for example, the processor 210 included in the swapped sector identification system 200 or a processor in a processing node. For discussion purposes, as an example, method 400 is described as being performed by the processor 210 included in the swapped sector identification system 200, which may be wholly or partially incorporated in the core network 102, RAN 122, and/or access node 110.

Method 400 starts in step 410, in which the processor 210 compares crowd-sourced samples to network data. As described above, the crowd-sourced samples may include reported location data from multiple wireless devices including geolocation data such as longitude and latitude. The network data may include antenna azimuth data, which may be stored in the network, for example, in the database 230.

In step 420, the processor 210 may calculate a delta between a measure of crowd-sourced samples and the network data. As set forth above, the measure may be or include a center of samples, calculated by averaging location data for each sample and dividing by the number of samples. The processor 210 may calculate the delta or angle between the antenna azimuth and center of samples as described above.

The processor 210 may compare the calculated delta to a predetermined threshold delta in step 430. The predetermined threshold delta may be set based on the network architecture. For example, the predetermined threshold delta may be set based on the number of sectors included in the cell site.

Based on the comparison of step 430, in step 440, the processor 210 may identify a swapped sector when the calculated delta meets or exceeds the predetermined threshold data. Due to the problems created by swapped sectors, the processor 210 may trigger a swapped sector notification or correction in step 450. The notification may be automatically relayed to network engineers or technicians in order to expedite repair.

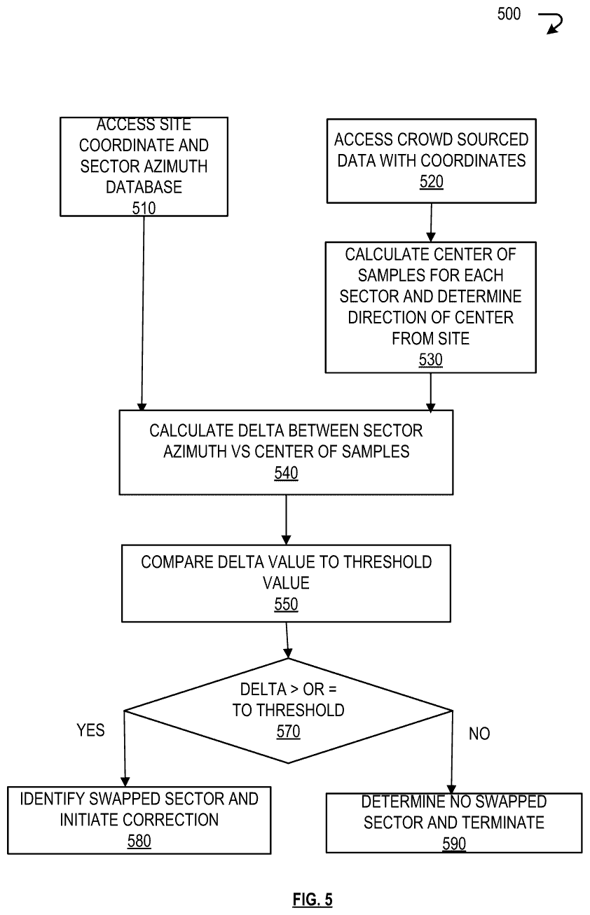

FIG. 5 depicts a further exemplary method 500 for operation of the swapped sector identification system 200. Method 500 may be performed by any suitable processor discussed herein, for example, the processor 210 included in the swapped sector identification system 200. For discussion purposes, as an example, method 500 is described as being performed by the processor 210 included in the swapped sector identification system 200, which may be wholly or partially incorporated in the core network 102, RAN 122, and/or access node 110.

Method 500 starts in step 510 in which the processor 210 access a database containing network data such as site coordinate and sector antenna azimuth data. Contemporaneously, or at another point in time, the processor 520 accesses the crowd-sourced data including latitude and longitude coordinates. The crowd-sourced data includes data routinely reported from wireless devices to the cell site. In step 530, the processor 210 calculates a center of samples for each sector and determines a direction of the center of samples from the cell site. The determination of the center of the crowd-sourced samples within each sector can be made by averaging the latitude and longitude coordinates of each sample. The center can be calculated by taking the average latitude and longitude and dividing by the number of samples.

After retrieving the sector azimuth from the database in step 510 and calculating the center of samples in step 530, a delta, or angle between the center of samples and the sector azimuth can be determined in step 540. The delta may be represented by drawing a curve between the center of samples and the antenna azimuth as shown, for example in FIGS. 3A and 3B.

In step 550, the processor 210 compares the delta value to a predetermined threshold delta value. For example, the predetermined threshold delta value in a site with three sectors may be approximately sixty degrees. In step 570, the processor 210 determines whether the calculated delta value from step 540 is greater than or equal to the predetermined threshold delta value. If the calculated delta value is greater than or equal to the predetermined threshold value in step 570, then the processor 210 identifies a swapped sector and initiates correction in step 580. However, if the calculated delta is less than the predetermined threshold delta value in step 570, the processor 210 determines that no swapped sector is identified and the process is terminated in step 590.

Accordingly, as set forth above, embodiments provide for swapped sector identification at a cell site. In some embodiments, methods 400 and 500 may include additional steps or operations. Additionally, the various scenarios may include interactions between additional components, which are omitted for ease of explanation. Furthermore, the methods may include steps shown in each of the other methods. Additionally, the order of steps shown is merely exemplary and the steps may be re-ordered as appropriate. As one of ordinary skill in the art would understand, the methods 400 and 500 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
comparing crowd-sourced samples from wireless devices to network data stored in a network database;
calculating a delta between the crowd-sourced samples and the network data; and
identifying a swapped sector based on the delta.

2. The method of claim 1, wherein the swapped sector occurs when coverage areas of two or more co-located sectors are inadvertently swapped.

3. The method of claim 1, wherein the crowd-sourced samples from wireless devices comprise geolocation data and signal strength data.

4. The method of claim 3, wherein the network data comprises site coordinate and sector antenna azimuth data.

5. The method of claim 4, further comprising calculating a center of the crowd-sourced samples by averaging geolocation coordinates from each wireless device.

6. The method of claim 5, further comprising calculating a direction of the center of the crowd-sourced samples from a site location.

7. The method of claim 5, wherein calculating the delta comprises calculating the delta between the sector antenna azimuth and the center of the crowd-sourced samples.

8. The method of claim 7, further comprising comparing the delta to a predetermined threshold.

9. The method of claim 8, further comprising determining the delta exceeds the predetermined threshold.

10. The method of claim 9, further comprising identifying the swapped sector based on the determination that the delta exceeds the predetermined threshold.

11. The method of claim 9, wherein the predetermined threshold is between fifty degrees and seventy degrees.

12. A system comprising:
a memory storing data and instructions; and
a processor executing the stored instructions to perform operations including:
comparing crowd-sourced samples from wireless devices to network data stored in a network database in the memory;
calculating a delta between the crowd-sourced samples and the network data; and identifying a swapped sector based on the delta.

13. The system of claim 12, wherein the crowd-sourced samples from wireless devices comprises geolocation coordinates and wherein the network data comprises site coordinates and sector antenna azimuth data.

14. The system of claim 13, further comprising calculating a center of the crowd-sourced samples by averaging geolocation coordinates from each wireless device.

15. The system of claim 14, wherein calculating the delta comprises calculating the delta between the sector antenna azimuth and the center of the crowd-sourced samples.

16. The system of claim 15, further comprising comparing the delta to a predetermined threshold and identifying the swapped sector based on the delta exceeding the predetermined threshold.

17. A non-transitory computer-readable medium storing instructions executed by a processor to perform operations comprising:
comparing crowd-sourced samples from wireless devices to network data stored in a network database;
calculating a delta between the crowd-sourced samples and the network data; and
identifying a swapped sector based on the delta.

18. The non-transitory computer-readable medium of claim 17, wherein the crowd-sourced samples from wireless devices comprises geolocation coordinates and the operations further comprise calculating a center of the crowd-sourced samples by averaging the geolocation coordinates from each wireless device.

19. The non-transitory computer readable medium of claim 18, wherein calculating the delta comprises calculating the delta between a sector antenna azimuth and the center of the crowd-sourced samples.

20. The non-transitory computer readable medium of claim 19, the operations further comprising comparing the delta to a predetermined threshold and identifying the swapped sector based on the delta exceeding the predetermined threshold.
